(19) United States
(12) Patent Application Publication
(10) Pub. No.: US 2008/0224811 A1
(43) Pub. Date: Sep. 18, 2008

(54) Magnetic core-coil device

(75) Inventor: Wan-Shiun Wang, Hsin-Chu Hsien (TW)

Correspondence Address: DLA PIPER US LLP, 2000 UNIVERSITY AVENUE, E. PALO ALTO, CA, 94303-2248, US

(73) Assignee: Shih-Jen Wang, et al.

(21) Appl. No.: 11/717,508

(22) Filed: Mar. 12, 2007

(51) Int. Cl. H01F 5/02; H01F 5/06

(52) U.S. Cl. 336/200

(57) ABSTRACT

A core-coil device includes: a printed circuit board having upper and lower surfaces and formed with a pair of through-holes that are spaced apart from each other and that extend through the upper and lower surfaces, the printed circuit board being further formed with at least one conductive coil winding that surrounds one of the through-holes; and at least one loop-shaped magnetic core of an integrally molded single piece extending through said one of the through-holes in the printed circuit board.

### BACKGROUND OF THE INVENTION

1. Field of the Invention

This invention relates to a magnetic core-coil device, more particularly to a magnetic core-coil device including a loop-shaped magnetic core of an integrally molded single piece extending through a through-hole in a printed circuit board that is surrounded by a coil winding formed on the printed circuit board.

2. Description of the Related Art

It is known in the art that magnetic core-coil devices, such as inductors, transformers and electromagnetic filters, normally include assemblies of magnetic cores and coil windings. Conventionally, when the coil winding is formed on a printed circuit board, the magnetic core is required to be cut into two halves so that one of the halves is disposed at one side of the printed circuit board and is extended through the printed circuit board to be connected with the other half that is disposed at an opposite side of the printed circuit board. The core-coil device thus formed is disadvantageous in that manufacturing of the same is tedious and time-consuming. Moreover, an undesired gap is formed between the magnetic core and upper and lower surfaces of the printed circuit board, which can result in undesired vibration, noise, and magnetic loss during-operation of the core-coil device.

### SUMMARY OF THE INVENTION

Therefore, the object of the present invention is to provide a core-coil device that can overcome the aforesaid drawbacks associated with the prior art.

According to this invention, there is provided a core-coil device that comprises: a printed circuit board having upper and lower surfaces and formed with a pair of through-holes that are spaced apart from each other and that extend through the upper and lower surfaces, the printed circuit board being further formed with at least one conductive coil winding that surrounds one of the through-holes; and at least one loop-shaped magnetic core of an integrally molded single piece extending through the through-holes in the printed circuit board.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of the first preferred embodiment of a core-coil device according to this invention;

FIG. 2 is a sectional view of the first preferred embodiment;

FIGS. 3 to 7 illustrate consecutive steps of a process for making the first preferred embodiment;

FIG. 8 is a perspective view of the second preferred embodiment of the core-coil device according to this invention;

FIG. 9 is a sectional view of the second preferred embodiment;

FIG. 10 is a perspective view of the third preferred embodiment of the core-coil device according to this invention;

FIG. 11 is a fragmentary sectional view of the third preferred embodiment; and

FIG. 12 is a perspective view of a core-coil package including the third preferred embodiment provided with metal leads and enclosed by an encapsulant.

### DETAILED DESCRIPTION OF THE PREFERRED EMBODIMENTS

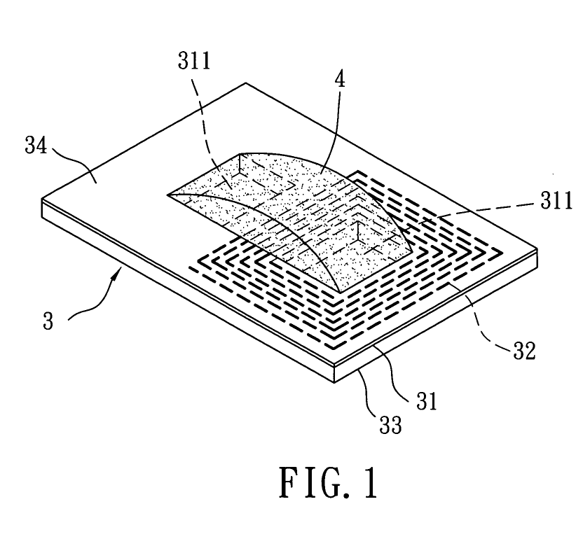

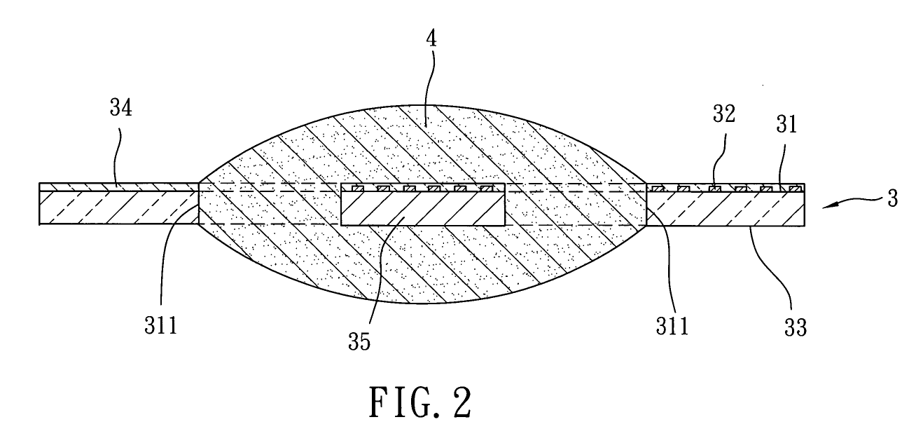

FIGS. 1 and 2 illustrate the first preferred embodiment of a core-coil device according to this invention. The core-coil device includes: a printed circuit board 3 having upper and lower surfaces 31, 33 and formed with a pair of through-holes 311 that are spaced apart from each other and that extend through the upper and lower surfaces 31, 33, the printed circuit board 3 being further formed with at least one conductive coil winding 32 that surrounds one of the through-holes 311; and at least one loop-shaped magnetic core 4 of an integrally molded single piece extending through the through-holes 32 in the printed circuit board 3. An insulator layer 34 is formed on the printed circuit board 3, and covers the coil winding 32 and a portion of the upper surface 31 of the printed circuit board 3 that is exposed from the coil winding 32.

The printed circuit board 3 has a core-enclosed portion 35 that extends between the through-holes 311. The magnetic core 4 is made from magnetic powder 7, and is molded over the upper and lower surfaces 31, 33 of the core-enclosed portion 35 of the printed circuit board 3 using techniques, such as compression molding and injection molding techniques.

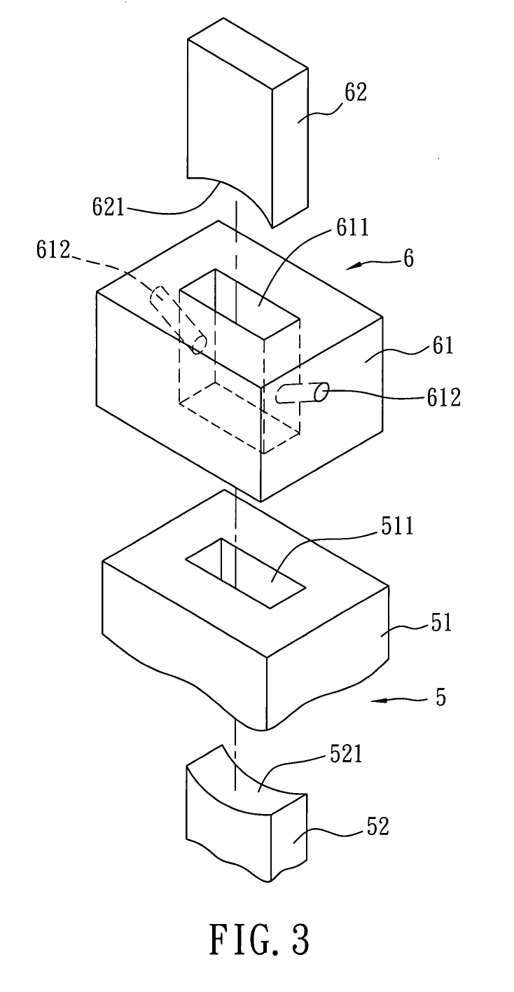

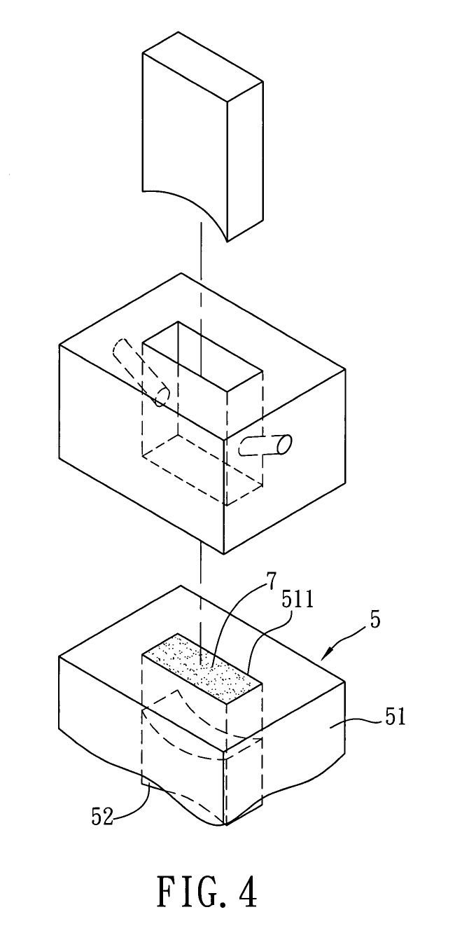

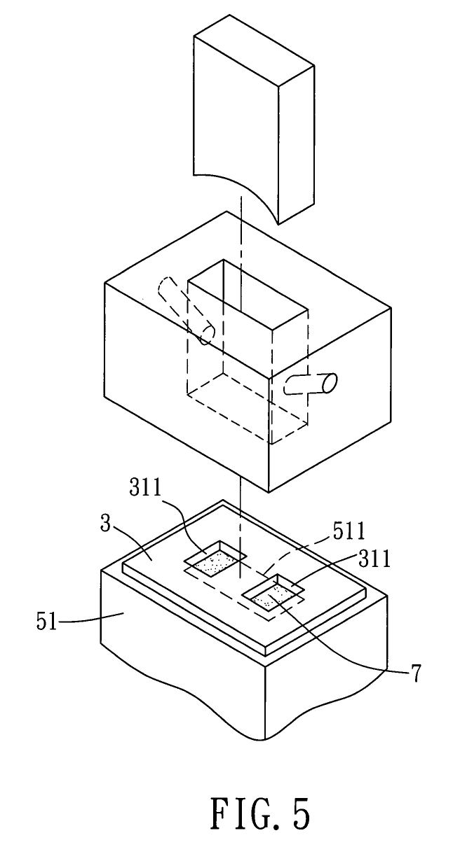

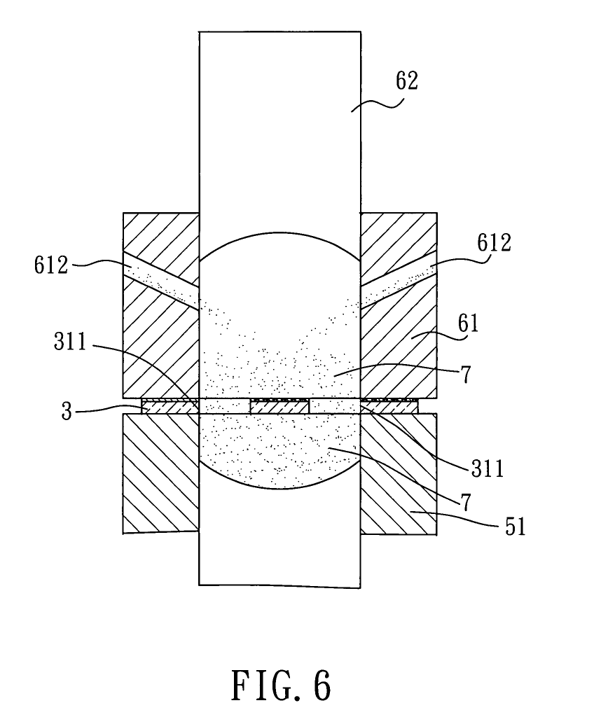

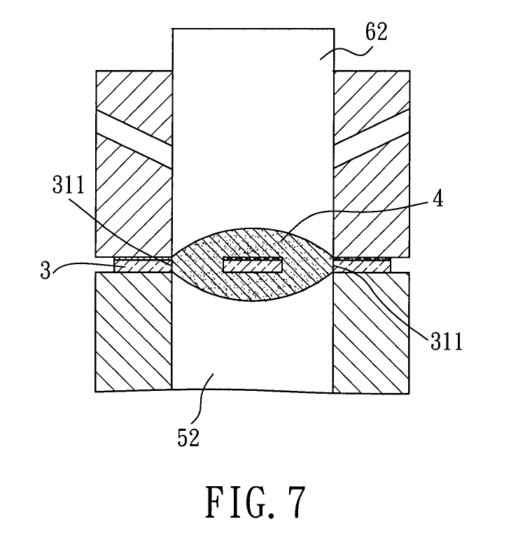

FIGS. 3 to 7 illustrate consecutive steps of a process for making the first preferred embodiment. The process includes the steps of: preparing lower and upper molds 5, 6 (see FIG. 3), the lower mold 5 including a lower mold body 51 that defines a lower cavity 511, and a lower plunger 52 that defines a first recess 521, the upper mold 6 including an upper mold body 61 that defines an upper cavity 611, and an upper plunger 62 that defines a second recess 621, the upper mold 6 being formed with a pair of feed holes 612 that are in fluid communication with the upper cavity 611; extending the lower plunger 52 into the lower cavity 511 such that the first recess 521 in the lower plunger 52 is in spatial communication with the lower cavity 511 and filling the first recess 521 and the lower cavity 511 with the magnetic powder 7 (see FIG. 4); placing the printed circuit board 3 on an upper surface of the lower mold 5 such that the through-holes 311 are aligned with the lower cavity 511 (see FIG. 5); extending the upper plunger 62 into the upper cavity 611 such that the second recess 621 in the upper plunger 62 is in spatial communication with the upper cavity 611 and moving the upper mold 6 together with the upper plunger 62 toward the lower mold 5 such that the printed circuit board 3 is sandwiched between the lower and upper molds 5, 6 and that the upper cavity 611 is aligned with the lower cavity 511 (see FIG. 6); feeding the magnetic powder 7 into the upper cavity 611 through the feed holes 612 (see FIG. 6); and moving the lower and upper plungers 52, 62 toward each other so as to compress and mold the magnetic powder 7 in the lower and upper cavities 511, 611 into the magnetic core 4 (see FIG. 7).

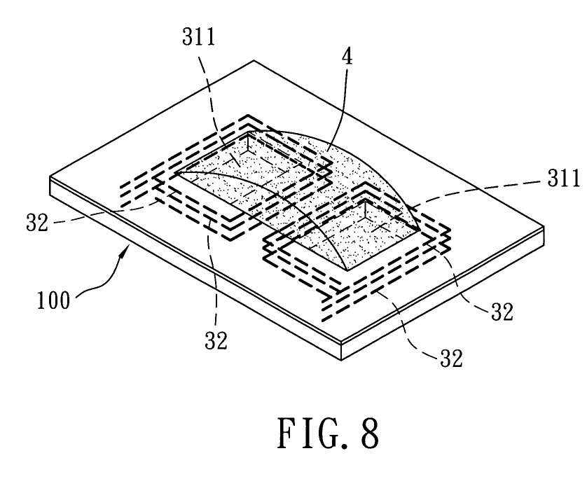

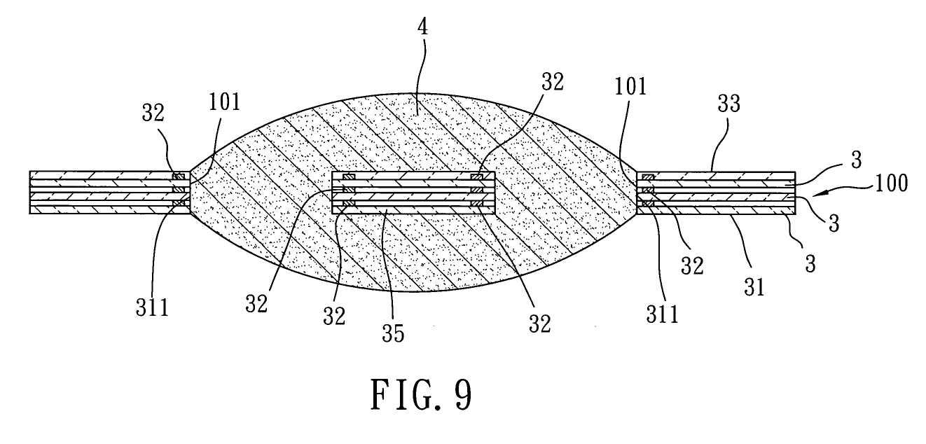

FIGS. 8 and 9 illustrate the second preferred embodiment of the core-coil device according to this invention. The second preferred embodiment differs from the previous embodiment in that a plurality of the printed circuit boards 3 are assembled into a stack 100 such that the through-holes 311 in the printed circuit boards 3 are aligned to form into a pair of core through-holes 101 in the stack 100 of the printed circuit boards 3 and that the loop-shaped magnetic core 4 extends through the core through-holes 101 in the stack 100 of the printed circuit boards 3. In this embodiment, the magnetic core 4 is molded over the upper surface 33 of the core-enclosed portion 35 of a topmost one of the printed circuit boards 3 and the lower surface 31 of the core-enclosed portion 35 of a bottommost one of the printed circuit boards 3. Note that the coil windings 32 between different levels of the printed circuit boards 3 can be electrically connected through formation of interconnected vias (not shown) in the stack 100 of the printed circuit boards 3.

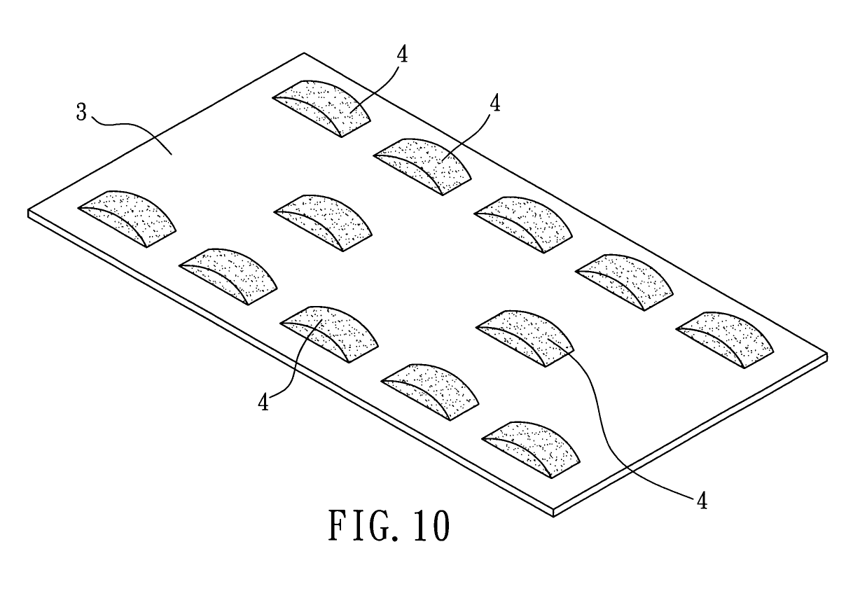

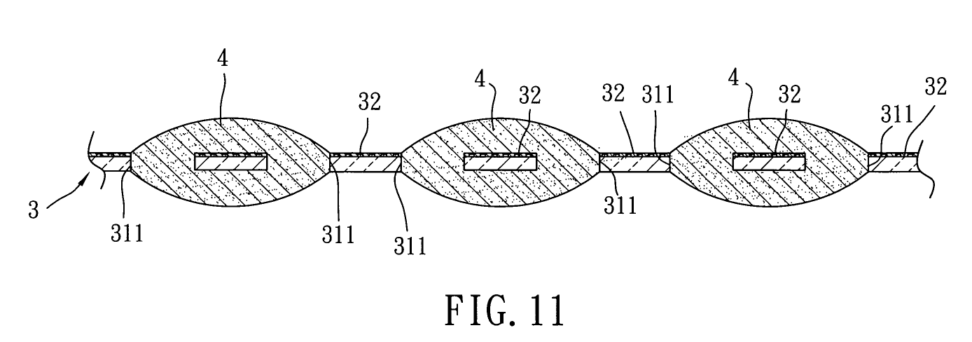

FIGS. 10 and 11 illustrate the third preferred embodiment of the core-coil device according to this invention. The third preferred embodiment differs from the first preferred embodiment in that the printed circuit board 3 is formed with a plurality of separate hole units, each of which includes a pair of the through-holes 311, and a plurality of coil units, each of which includes a pair of conductive coil windings 32 surrounding respectively the through-holes 311 of a respective one of the hole units, and that a plurality of the loop-shaped magnetic cores 4 are mounted on the printed circuit board 3. Each of the loop-shaped magnetic cores 4 extends through the through-holes 311 of a respective one of the hole units in the printed circuit board 3. Manufacturing of the third preferred embodiment can be conducted by using a corresponding number of compression molds, which results in a considerable reduction in production time and steps as compared to the conventional manufacturing process. In addition, the magnetic cores 4 can be made from different magnetic materials.

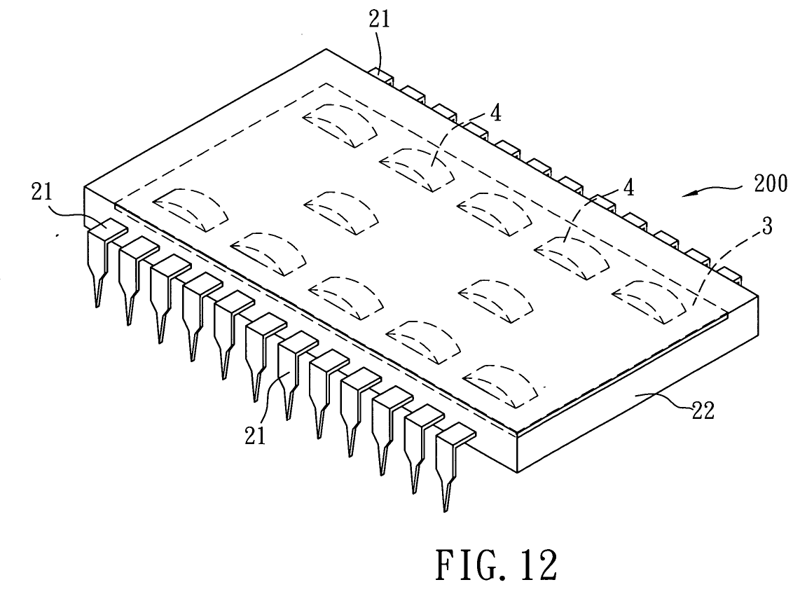

The core-coil device of this invention can be further processed into a chip-like package 200 as best illustrated in FIG. 12. The core-coil package 200 includes the core-coil device of the third preferred embodiment which is further provided with metal leads 21 and enclosed by an encapsulant 22.

By molding the magnetic powder 7 over the core-enclosing portion 35 of the printed circuit board 3 to form an integral single piece of the magnetic core 4 of the core-coil device of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A magnetic core-coil device comprising:
a printed circuit board having upper and lower surfaces and formed with a pair of through-holes that are spaced apart from each other and that extend through said upper and lower surfaces, said printed circuit board being further formed with at least one conductive coil winding that surrounds one of said through-holes; and
at least one loop-shaped magnetic core of an integrally molded single piece extending through said through-holes in said printed circuit board.

2. The magnetic core-coil device of claim 1, wherein said printed circuit board has a core-enclosed portion that extends between said through-holes, said loop-shaped magnetic core being made from magnetic powder and being molded over said upper and lower surfaces of said core-enclosed portion of said printed circuit board.

3. The magnetic core-coil device of claim 1, wherein said printed circuit board is further formed with an insulator layer that covers said coil winding and a portion of said upper surface of said printed circuit board that is exposed from said coil winding.

4. A magnetic core-coil device comprising:
a printed circuit board having upper and lower surfaces and formed with a plurality of separate hole units, each of which includes a pair of through-holes that are spaced apart from each other and that extend through said upper and lower surfaces, said printed circuit board being further formed with a plurality of coil units, each of which includes a pair of conductive coil windings that surround respectively said through-holes of a respective one of said hole units; and
a plurality of loop-shaped magnetic cores, each of which is in the form of an integrally molded single piece and each of which extends through said through-holes of a respective one of said hole units in said printed circuit board.

5. The magnetic core-coil device of claim 4, wherein said printed circuit board has a plurality of core-enclosed portions, each of which extends between said through-holes of a respective one of said hole units, each of said magnetic cores being made from magnetic powder and being molded over said upper and lower surfaces of a respective one of said core-enclosed portions of said printed circuit board.

6. A magnetic core-coil device comprising:
a stack of printed circuit boards, each of which has upper and lower surfaces and each of which is formed with a pair of through-holes that extend through said upper and lower surfaces, said through-holes in said printed circuit boards being aligned to form into a pair of core through-holes in said stack of said printed circuit boards, each of said printed circuit boards being further formed with a conductive coil winding that surrounds one of said through-holes in a respective one of said printed circuit boards; and
a loop-shaped magnetic core of an integrally molded single piece extending through said core through-holes in said stack of said printed circuit boards.

7. The magnetic core-coil device of claim 6, wherein each of said printed circuit boards has a core-enclosed portion extending between said through-holes in a respective one of said printed circuit boards, said magnetic core being made from magnetic powder and being molded over said upper surface of said core-enclosed portion of a topmost one of said printed circuit boards and said lower surface of said core-enclosed portion of a bottommost one of said printed circuit boards.
